(19) United States
(12) Patent Application Publication
(10) Pub. No.: US 2017/0097299 A1
(43) Pub. Date: Apr. 6, 2017

(54) METHOD FOR DETERMINING COLOR CHARACTERISTICS REFLECTED BY AN INTERFERENCE FILTER, METHOD FOR DEPOSITING SUCH AN INTERFERENCE FILTER, AND ASSEMBLY FORMED BY AN INTERFERENCE FILTER AND AN OBJECT

(71) Applicant: ESSILOR INTERNATIONAL(COMPAGNIE GENERALE D'OPTIQUE, Charenton Le Pont (FR)

(72) Inventors: Frederic ARROUY, Charenton Le Pont (FR); Francisco DE AYGUAVIVES, Charenton Le Pont (FR)

(73) Assignee: ESSILOR INTERNATIONAL(COMPAGNIE GENERALE D'OPTIQUE, Charenton Le Pont (FR)

(21) Appl. No.: 15/312,134

(22) PCT Filed: May 18, 2015
(86) PCT No.: PCT/FR2015/051288

§ 371 Date: Nov. 17, 2016

(30) Foreign Application Priority Data
May 19, 2014 (FR) 1454475

(51) Int. Cl. G01N 21/25; C23C 28/04; G02B 5/28; G02B 27/00; G01J 3/46; G01M 11/02

(52) U.S. Cl. CPC G01N 21/251; G01J 3/463; G01M 11/02; G01J 3/462; G02B 5/285; G02B 27/0012; C23C 28/042

(57) ABSTRACT

A method for determining color characteristics reflected by an interference filter, a method for depositing such an interference filter, and an assembly of an interference filter and an object, the method including: determining color coordinates of an object; and determining at least one color characteristic reflected by the interference filter according to the determined color coordinates, respecting an isoperception law.

### TECHNICAL FIELD OF THE INVENTION

The present invention generally relates to interference filters (produced in the form of interference stacks) deposited for example on an optical article, such as an ophthalmic lens.

It more particularly relates to a method for determining colorimetric characteristics in reflection of an interference filter.

The present invention also relates to a method for depositing an interference filter on an optical article, and to an assembly formed from an interference filter and an object.

### PRIOR ART

It is known to deposit interference filters, generally produced in the form of stacks of thin films, on optical articles, such as ophthalmic lenses, in order to obtain a particular effect, for example an antireflection treatment or a mirror-like appearance.

Depending on the physical characteristics of the interference filter used, the light reflected by the article may have a certain color. When this effect is not controlled, it may prove to be disadvantageous, in particular because of the variability of the color from one lens to the next. In the case of ophthalmic lenses, color variability is for example problematic in the case of use in a pair of spectacles, in which case two separate lenses are placed close to each other.

In contrast, it has been proposed in patent application FR 2 896 045 to make use of differences in colorimetric characteristics by producing optical articles the antireflection coatings of which have residual reflection colors of different intensities.

### SUBJECT OF THE INVENTION

In this context, the present invention provides a method for determining colorimetric characteristics in reflection of an interference filter, characterized in that it comprises the following steps:
determining colorimetric coordinates of an object;
determining at least one colorimetric characteristic in reflection of the interference filter depending on the determined colorimetric coordinates while respecting an iso-perception law.

Thus, the colorimetric characteristics of an interference filter that will have a reflection of a color perceived to be identical to that of the object are determined using an objective approach. This is in particular advantageous when the object is intended to be located in proximity to the interference filter, for example when the object is a spectacle frame and the interference filter is intended to be deposited on a spectacle or eyeglass to be fitted in the frame. This is also advantageous when it is desired to obtain a reflection of a particular color, for example a color associated with the image of a company or a brand.

As explained in greater detail below, the method for determining colorimetric characteristics is typically implemented by means of an apparatus designed for this purpose, for example a computer programmed for this purpose.

The colorimetric characteristic in reflection may be determined depending on a reflectance desired for the interference filter. Specifically, the reflectance may in this case be chosen depending on the application.

The reflectance may be the visual reflectance (R_{V}), also called the mean luminous reflectance, which corresponds to the reflection coefficient in all the visible spectrum between 380 and 780 nm weighted by the curve of energy sensitivity of the human eye, or the mean reflectance (Rₘ) i.e. the (unweighted) mean of the spectral reflection in all the visible spectrum between 400 et 700 nm. These factors are well known to those skilled in the art. The “mean reflectance”, denoted Rₘ, is defined in standard ISO 13666:1998 and may be measured directly on the articles obtained by the method of the invention according to standard ISO 8980-4 (at an angle of incidence smaller than 17°, typically15°).

The “mean luminous reflectance”, denoted R_{V}, is defined in standard ISO 13666:1998. It may be measured directly on the articles obtained by the method of the invention according to standard ISO 8980-4 (at an angle of incidence smaller than 17°, typically15°).

The colorimetric coordinates of the object may especially include a lightness level of the object and a color saturation value of the object; the step of determining at least one colorimetric characteristic in reflection of the interference filter may then comprise the following substeps:
converting the lightness level of the object into an equivalent reflectance;
determining a color-in-reflection saturation value of the interference filter depending on the reflectance desired for the interference filter, on the equivalent reflectance and on the color saturation value of the object while respecting an iso-perception law.

As explained below, the thus determined color-in-reflection saturation value of the interference filter allows a given perception of the color in reflection from the interference filter and of the color of the object to be obtained despite any difference that there may be between the reflectances of the interference filter and the object.

According to optional, i.e. nonlimiting, features provided by the invention:
the equivalent reflectance and the desired reflectance are visual reflectances;
the step of determining the color-in-reflection saturation value of the interference filter is such that a ratio of the color-in-reflection saturation value of the interference filter to the desired reflectance is equal to a ratio of the color saturation value of the object to the equivalent reflectance;
the colorimetric coordinates of the object comprise a hue value of the object;
the method comprises a step of determining the hue value in reflection of the interference filter depending on the value of the object;
the determined hue value is identical to the hue value of the object;
the step of determining the colorimetric coordinates of the object comprises a step of measurement using a colorimeter;
the step of determining colorimetric coordinates comprises a step of converting measured colorimetric coordinates into polar coordinates (for example especially including the color saturation value of the object and the hue value of the object);
the object has a color associated with a brand or a company;
the interference filter is intended to be deposited on an optical article, such as an ophthalmic lens, for example a spectacle eyeglass;
the object is a spectacle frame, for example intended to carry the aforementioned spectacle eyeglass.

The interference filter is for example deposited, in particular in the case of an antireflection treatment or to obtain a mirror-like appearance, on the front face of the ophthalmic lens, i.e. the face of the ophthalmic lens located opposite the eye of the spectacle wearer with respect to the ophthalmic lens.

The invention also provides a method for depositing an interference filter on an optical article, characterized in that it comprises the following steps:
determining colorimetric characteristics in reflection of the interference filter using a method such as described above;
determining physical characteristics of the interference filter depending on the determined colorimetric characteristics;
depositing the interference filter on the optical article with the determined physical characteristics.

The step of determining physical characteristics may comprise a step of simulating numerically the physical behavior of an interference filter.

The interference filter is for example produced in the form of an interference stack comprising a plurality of layers and the step of determining the physical characteristics of the interference filter may then comprise a step of determining the respective thicknesses of said layers.

The interference stack for example comprises a stack made up of high refractive index layers alternated with low refractive index layers.

By high refractive index layer (also called an HI layer), what is meant is a layer having a refractive index higher than or equal to 1.50, preferably higher than or equal to 1.60, better still higher than or equal to 1.8, and in particular from 1.8 to 2.2; and by layer of low refractive index (called an LI layer), what is meant is a layer having a refractive index lower than 1.50 and preferably lower than 1.48. Unless otherwise indicated, all the refractive indices indicated in the present patent application are expressed for a reference wavelength of 550 nm and at a temperature of 25° C.

Generally, the high refractive index (HI) layers comprise, nonlimitingly, one or more metal oxides such as TiO₂, PrTiO₃, LaTiO₃, ZrO₂, Te₂O₅, Y₂O₃, Ce₂O₃, La₂O₃, Dy₂O₅, Nd₂O₅, HfO₂, Sc₂O₃, Pr₂O₃ or Al₂O₃, and Si₃N₄, or one of the mixtures thereof, preferably ZrO₂, TiO₂, or Pr₂O₃, and in particular ZrO₂. The high refractive index layers may optionally comprise low refractive index materials such as SiO₂. The one or more mixtures of these materials are such that the resulting layer has a refractive index such as defined above, namely higher than or equal to 1.50.

The low refractive index (LI) layers for example comprise nonlimitingly SiO₂, SiOₓ where 1≦x<2, MgF₂, ZrF₄, Al₂O₃, AlF₃, chiolite (Na₃Al₃F₁₄), cryolite (Na₃[AlF₆]), or a mixture thereof, preferably SiO₂ or SiO₂ doped with Al₂O₃ which allows the critical temperature of the stack to be increased. In particular, the low refractive index layer comprises SiO₂. Also, the one or more mixtures of these materials are such that the resulting layer has a refractive index such as defined above, namely lower than 1.50.

When the mixture SiO₂/Al₂O₃ is used, the low refractive index layer preferably contains from 1 to 10%, in particular from 1 to 8% and even better still from 1 to 5% by weight Al₂O₃ relative to the total weight of silica and alumina in this layer. Specifically, too high a proportion of alumina may be prejudicial to the adhesion of the coating.

For example, layers of SiO₂ doped with 4% or less Al₂O₃ by weight, or a layer of SiO₂ doped with 8% Al₂O₃ may be employed. Commercially available SiO₂ /Al₂O₃ mixtures may be used, such as the LIMA® mixture sold by UMICORE MATERIALS AG (refractive index comprised between 1.48 and 1.50) or the substance L5® sold by MERCK KGaA (refractive index equal to 1.48 for a wavelength of 500 nm).

Typically, the one or more low index layers consist of SiO₂ and the one or more high refractive index layers consist of ZrO₂.

The interference stack for example comprises the same number of high and low refractive index layers.

Generally, the interference stack comprises from 4 to 6 layers, typically 4 layers, without taking into account an optional sublayer.

In one envisionable embodiment, the interference stack comprises, starting from the face of the substrate, a first high refractive index layer made of ZrO₂, a second low refractive index layer made of SiO₂, a third high refractive index layer made of ZrO₂ and a fourth low refractive index layer made of SiO₂.

For example, the interference coating comprises a stack from the substrate of at least four successive layers having the following physical thicknesses:
from 100 to 120 nm for the high refractive index layer, such as ZrO₂; and
from 110 to 140 nm for the low refractive index layer, such as SiO₂;
from 75 to 95 nm for the high refractive index layer, such as ZrO₂; and
from 55 to 77 nm for the low refractive index layer, such as SiO₂.

In general, the ratio (total physical thickness of the low refractive index layers)/(total physical thickness of the high refractive index layers) of the layers of the interference stack varies from 0.6 to 1.2.

Unless otherwise indicated, all the layer thicknesses disclosed in the present application are physical thicknesses, and not optical thicknesses.

Moreover, the interference stack is for example deposited on a bonding sublayer, for example made of SiO₂, between the stack of alternated high and low refractive index layers and the face of the substrate.

This bonding sublayer in general has a thickness from 50 to 250 nm. The layers of the interference stack, for example with a view to producing an antireflection treatment or a mirror-like appearance, may be deposited by any known means such as by evaporation, optionally assisted by ion beams, by ion beam sputtering, by cathode sputtering, or by plasma enhanced chemical vapor deposition or by evaporation in a vacuum chamber.

The layers of the interference stack may also be deposited by high-pressure cathode sputtering.

The substrate of the ophthalmic lens is preferably made of organic glass, for example of a thermoplastic or thermoset.

Regarding thermoplastics suitable for the substrates, mention may be made of (meth)acrylic (co)polymers, in particular polymethyl methacrylate (PMMA), thio(meth)acrylic (co)polymers, polyvinyl butyral (PVB), polycarbonates (PC), polyurethanes (PU), polythiourethanes, polyol(allyl carbonate) (co)polymers, thermoplastic ethylene/vinyl acetate copolymers, polyesters such as polyethylene terephthalate (PET) or polybutylene terephthalate (PBT), polyepisulfides, polyepoxides, polycarbonate/polyester copolymers, cyclic olefin copolymers such as ethylene/norbornene or ethylene/cyclopentadiene copolymers and their blends.

The term “(co)polymer” is understood to mean a copolymer or a homopolymer. The term “(meth)acrylate” is understood to mean an acrylate or a methacrylate. The term “polycarbonate (PC)” is understood in the context of the present invention to mean both homopolycarbonates and copolycarbonates and sequenced copolycarbonates.

Particularly recommended substrates are substrates obtained by (co)polymerization of diethyleneglycol bis allylcarbonate, sold, for example, under the commercial denomination CR-39® by PPG Industries (ESSILOR ORMA® lenses), or by polymerization of thio(meth)acrylic monomers, such as those described in French patent application FR 2734827. The substrates may be obtained by polymerization of blends of the above monomers, or may even comprise blends of these polymers and (co)polymers.

Other usable substrates are the polycarbonates.

The interference stack may be deposited on a bare substrate, i.e. the main faces of which are uncoated, or on an already coated substrate, i.e. the main faces of which are coated with one or more functional coatings.

Specifically, a coating or a layer that is “on” the substrate or that has been deposited “on” the substrate is defined as a coating that:
(i) is positioned above one of the main faces of the bare substrate;
(ii) does not necessarily make contact with the substrate (although preferably it does), i.e. one or more intermediate, generally functional, coatings may be placed between the bare substrate and the coating in question; and
(iii) does not necessarily completely cover the main face of the substrate (although preferably it is covered thereby).

Functional coatings are well known and comprise, by way of example, a primer for adhesion and/or shock resistance and/or an abrasion resistant coating and/or a polarization coating and/or a photochromic coating.

Lastly, the invention provides an assembly formed from an interference filter and an object having a color represented by determined colorimetric coordinates, characterized in that at least one colorimetric characteristic in reflection of the interference filter and the colorimetric coordinates of the object respect an iso-perception law.

The object may be physically close to the ophthalmic lens as will be described below or distant therefrom. In the latter case, one example is the case of a well-known brand associated with a specific color that is easily recognizable.

As already indicated, the interference filter may be deposited on a spectacle eyeglass and the object may then be a spectacle frame carrying said eyeglass.

### DETAILED DESCRIPTION OF AN EXEMPLARY EMBODIMENT

The description which follows with reference to the appended drawings, which are given by way of nonlimiting examples, will make it easy to understand the essence of the invention and how it can be achieved. In the appended drawings:

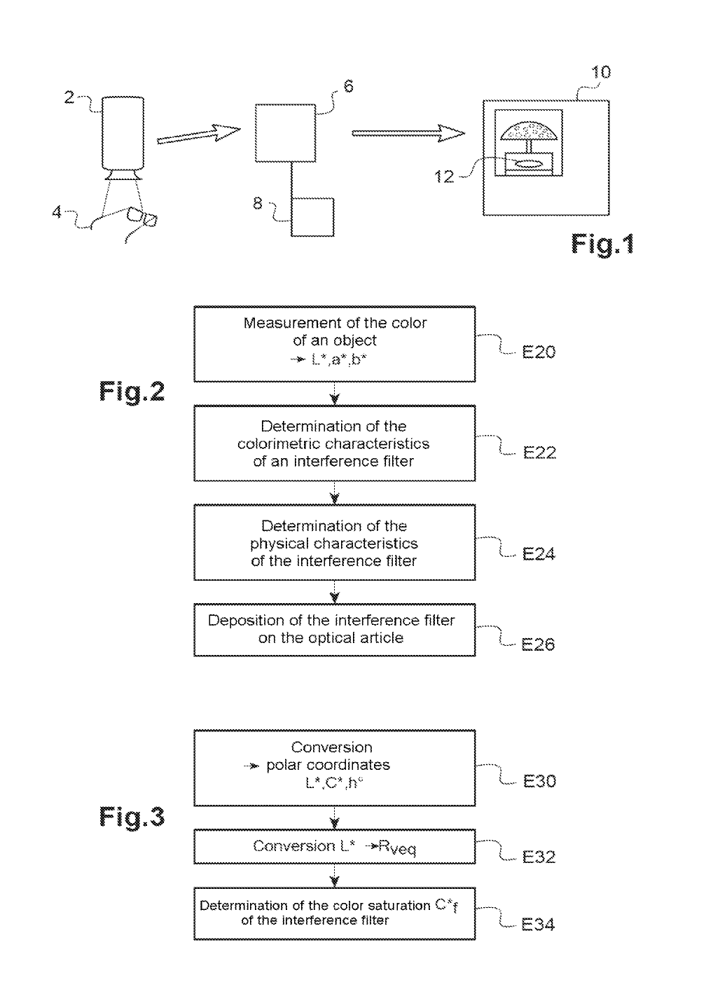

FIG. 1 shows an exemplary context in which the invention may be implemented;

FIG. 2 shows the main steps of a method for depositing an interference filter on an optical article in accordance with the teachings of the invention;

FIG. 3 shows the main steps of a method for determining the colorimetric characteristics in reflection of such an interference filter, in accordance with the teachings of the invention.

FIG. 1 schematically shows an object 4 (here a spectacle frame), and an ophthalmic lens 12 (here an eyeglass intended to be fitted in the lens) on which it is desired to deposit an interference filter (for example with the aim of obtaining an antireflection treatment or a mirror-like appearance) having a color in reflection perceived by an observer as identical to the color of the object.

The methods described below with reference to FIGS. 2 and 3 are especially implemented by means of a computer programmed for this purpose, which comprises a processor 6 (for example a microprocessor) and data-storing means 8 (for example a semiconductor memory or, as a variant, a hard disk).

The data-storing means 8 especially store a computer program that is suitable, when it is executed by the processor 6, for implementing certain steps of the methods in FIGS. 2 and 3; the data-storing means 8 also store the data used in the context of the implementation of these methods, as explained below.

Other elements shown in FIG. 1 are presented below.

An exemplary method for depositing an interference filter on an optical article (here the ophthalmic lens 12) will now be described with reference to FIG. 2.

This method starts with a step E20 in which certain colorimetric characteristics of the object 4 are measured using an apparatus for measuring color, for example a colorimeter 2.

Here the colorimeter 2 used was a “Color Reader” CR-10 supplied by Konica Minolta®, which measures the colorimetric coordinates L*, a*, b* of the object in the L*a*b* colorimetric space defined by the Commission Internationale de lÉclairage (CIE), for the standard observer at 10° under standard illuminant D65, both also defined by the CIE.

As already indicated, the object is for example a frame 4 intended to receive the ophthalmic lens, or a colored portion of this frame. As a variant, the object could be a logo of a company or a brand (or a colored portion of such a logo or of such a brand), for example is such as represented on a printed medium. According to another envisionable embodiment, the object could be a color plate (the color of the plate for example corresponding to a Pantone hue).

In the described example, the frame 4 is for example red in color and the measurement performed by the colorimeter 2 gives the following colorimetric coordinates for the color of the frame 4: L*=43.4; a*=54 ; b*=26.

The method in FIG. 1 continues with a step E22 of determining the colorimetric characteristics of the interference filter, here depending on the colorimetric coordinates of the object i.e. the color metric coordinates such as measured in step E20. To do this, the measured colorimetric coordinates are for example transmitted from the colorimeter 2 to the processor 6 by exchanging means (for example a wired connection or wireless communicating means).

This determining step E22 is carried out by the processor 6, as described in detail below with reference to FIG. 3, while respecting an iso-perception law so that the interference filter has a reflection of a color perceived as identical to that of the object 4.

In the aforementioned case of the frame, and if it is desired to obtain an antireflection treatment characterized by a visual reflectance R_{Vf} of 1% (see the description of FIG. 3 below on this subject), a saturation value C*_{f}=4.5 and a hue value h*_{f}=26, which characterize the color in reflection of the interference filter, are obtained as explained below.

Next, in step E24, the physical characteristics of the interference filter (typically the number, the thickness and the material of the thin layers forming the interference filter) that allow the colorimetric characteristics determined in step E22 to be obtained are determined.

This step E24 of determining physical characteristics is for example carried out by implementing, by means of the processor 6, a numerical simulation of the physical behavior of the interference filter. This numerical simulation is carried out by executing, in the processor 6, a simulation software package, for example the software package “The Essential Macleod”.

In the case of the aforementioned antireflection treatment, and if for example an interference stack formed from an alternation of layers of ZrO₂ and of SiO₂, with 4 layers in total is used, step E24 gives the following values for the thickness of the layers (in order to obtain an interference filter having the colorimetric characteristics of the above example), starting from the substrate:

1^{st} layer ([ZrO₂]): [23 nm]; 2^{nd} layer ([SiO₂]): [19 nm]; 3^{rd} layer ([ZrO₂]): [85 nm]; 4^{th} layer ([SiO₂]): [71 nm].

Lastly, on the ophthalmic lens 12 and by means of a piece of vacuum deposition equipment 10, thin layers having the determined physical characteristics are deposited, thereby allowing an interference filter (here an antireflection treatment) to be obtained the color in reflection of which is perceived as identical to that of the object 4 (in this instance the frame intended to receive this lens). To do this, the operation of the piece of vacuum deposition equipment 10 is for example controlled by the processor 6.

An exemplary method for determining the colorimetric characteristics in reflection of an interference filter will now be described with reference to FIG. 3 and by means of which the aforementioned step E22 is implemented. This method is for example implemented by the processor 6 by way of the execution of instructions of a computer program written for this purpose.

This method starts in step E30 with the conversion of the measured colorimetric coordinates L*, a*, b* into polar coordinates L*, C*, h°.

The hue h° and the saturation (or chroma) C* of the measured color are defined as h°=(180/π)·arctan(b*/a*) and C*=(a*²+b*²)^{1/2} (namely in the aforementioned example h°=26° and C*=59.93).

It will be noted that the coordinate L* (which represents the lightness of the color of the object) is used in both representations and is therefore not modified by step E30.

Next, in step E32, this lightness value L* is converted into an equivalent visual reflectance R_{Veq}.

The visual reflectance corresponds by definition to the Y coordinates of the XYZ colorimetric space defined by the CIE. The lightness value L* of the object and the equivalent visual reflectance R_{Veq} are therefore related by the following equations (which are based on the formulae for converting coordinates in the XYZ space to coordinates in the L*a*b* space):

L*=116·(R_{veq}/Yᵣ)^{1/3}−16

if R_{V}/Yᵣ>0.008856; and

L*=903.3·R_{Veq}/Yᵣ

if not, where Yᵣ is the Y coordinate in the XYZ space of the illuminant used to construct the L*a*b* space in question.

When the standard illuminant D65 is used as is the case here as already indicated, these formulae may be written:

L*=25·R_{Veq}^{1/3}−16

### if R_{Veq}>0.9%; and

L*=9·R_{Veq}

if not.

In the aforementioned example where L*=43.4, R_{Veq}=13.41%.

It has thus been possible to determine characteristics representative of the color of the object (in the described example, of the frame 4): the equivalent visual reflectance R_{Veq}, the saturation C* and the hue h°.

It is proposed to determine the colorimetric characteristics in reflection of the interference filter on the basis of these characteristics representative of the color of the object, while respecting a law of iso-perception of the color.

In the example described here, the visual reflectance R_{Vf} of the interference filter is predefined (for example input via inputting means associated with the processor 6 and stored in the data-storing means 8) depending on the targeted application. In the case of an antireflection-treatment application, a value R_{Vf} lower than 2.5% and typically comprised between 0.1% and 2.5%, here a value R_{Vf}=1 %, is for example selected. As a variant, if the targeted application was for example a mirror effect, the predefined visual reflectance R_{Vf} could for example be comprised between 10 and 80% and preferably between 40 and 60%.

In order to obtain an identical hue for the object and the radiation reflected by the interference filter, the hue value h°_{f} in reflection of the interference filter is determined as equal to the hue value of the object h°, i.e. the hue value such as obtained in step E30.

Regarding the saturation, the inventors have noted that for a given saturation value the perceived color varies if the visual reflectance is varied. In contrast, it has been noted that for a given hue and saturation, the more the visual reflectance increases, the more the color represented by this visual reflectance and the given saturation and hue is perceived as achromatic.

Therefore, it is proposed here to determine the color-in-reflection saturation C*_{f} of the interference filter on the basis of the visual reflectance factor R_{Vf} defined beforehand for the interference filter, of the equivalent reflectance R_{Veq} and of the saturation value C* of the object (determined in step E30) while respecting an iso-perception law, for example such that the ratio of the visual reflectance R_{Veq} to the saturation C* (characteristics of the object) are identical to the ratio of the visual reflectance R_{Vf} to the saturation C*_{f} (characteristics of the interference filter).

In other words, the color-in-reflection saturation C*_{f} of the interference filter is:

C*_{f}=C* ·R_{Vf}/R_{Veq}.

Specifically, the inventors have observed that keeping a constant R_{V}/C* ratio makes it possible to ensure that the color perceived by the Observer remains the same.

In the aforementioned example, the following is thus obtained: C*_{f}=4.5.

It has thus been possible to determine characteristics representative of the color in reflection of the interference filter, said characteristics being such that this color in reflection is perceived as the same as that of the object (in the described example, of the frame 4): the visual reflectance R_{Vf} (here selected by the user), the saturation C*_{f} and the hue h°_{f}.

1-16. (canceled)

17. A method for determining colorimetric characteristics in reflection of an interference filter, the method comprising:
determining colorimetric coordinates of an object;
determining at least one colorimetric characteristic in reflection of the interference filter depending on the determined colorimetric coordinates while respecting an iso-perception law.

18. The method as claimed in claim 17, wherein the colorimetric characteristic in reflection is determined depending on a reflectance desired for the interference filter.

19. The method as claimed in claim 18, wherein the calorimetric coordinates of the object include a lightness level of the object and a color saturation value of the object and wherein the determining at least one colorimetric characteristic in reflection of the interference filter comprises:
converting the lightness level of the object into an equivalent reflectance;
determining a color-in-reflection saturation value of the interference filter depending on the reflectance desired for the interference filter, on the equivalent reflectance and on the color saturation value of the object while respecting an iso-perception law.

20. The method as claimed in claim 19, wherein the equivalent reflectance and the desired reflectance are visual reflectances.

21. The method as claimed in claim 20, wherein the determining the color-in-reflection saturation value of the interference filter is such that a ratio of the color-in-reflection saturation value of the interference filter to the desired reflectance is equal to a ratio of the color saturation value of the object to the equivalent reflectance.

22. The method as claimed in claim 17, wherein the colorimetric coordinates of the object comprise a hue value of the object, the method further comprising determining the hue value in reflection of the interference filter depending on the hue value of the object.

23. The method as claimed in claim 22, wherein the determined hue value is identical to the hue value of the object.

24. The method as claimed in claim 17, wherein the determining the colorimetric coordinates of the object comprises a measurement using a colorimeter.

25. The method as claimed in claim 24, wherein the determining colorimetric coordinates comprises converting measured colorimetric coordinates into polar coordinates.

26. The method as claimed in claim 17, wherein the object has a color associated with a brand or a company.

27. The method as claimed in claim 17, further comprising depositing the interference filter on an ophthalmic lens and wherein the object is a spectacle frame.

28. A method for depositing an interference filter on an optical article, the method comprising:
determining colorimetric characteristics in reflection of the interference filter using a method as claimed in claim 17;
determining physical characteristics of the interference filter depending on the determined colorimetric characteristics;
depositing the interference filter on the optical article with the determined physical characteristics.

29. The method as claimed in claim 28, wherein the determining physical characteristics comprises simulating numerically the physical behavior of an interference filter.

30. The method as claimed in claim 28, wherein the interference filter is produced in a form of an interference stack including a plurality of layers and wherein the determining the physical characteristics of the interference filter comprises determining respective thicknesses of the layers.

31. An assembly formed from an interference filter and an object having a color represented by determined colorimetric coordinates, wherein at least one colorimetric characteristic in reflection of the interference filter and the colorimetric coordinates of the object respect an iso-perception law.

32. The assembly as claimed in claim 31, wherein the interference filter is deposited on a spectacle eyeglass and wherein the object is a spectacle frame carrying the eyeglass.
